(19) United States
(12) Patent Application Publication
(10) Pub. No.: US 2025/0378358 A1
(43) Pub. Date: Dec. 11, 2025

(54) INTELLIGENT AND AUTOMATED SYSTEM FOR SOLVING COMPUTATIONAL PROBLEMS USING QUANTUM COMPUTATION

(71) Applicant: International Business Machines Corporation, Armonk, NY (US)

(72) Inventors: Juan Cruz Benito, Salamanca (ES); Ivan Duran Martinez, Elmsford, NY (US); Francisco Jose Martin Fernandez, Ridgefield, CT (US); Ismael Faro Sertage, Chappaqua, NY (US); David Kremer Garcia, Madrid (ES); Alexandra Rivero García, Santa Cruz de Tenerife (ES)

(21) Appl. No.: 18/734,805

(22) Filed: Jun. 5, 2024

(30) Foreign Application Priority Data
Apr. 4, 2024 (EP) 24382347.3

(51) Int. Cl. G06N 10/20; G06N 10/60

(52) U.S. Cl. CPC G06N 10/20; G06N 10/60

(57) ABSTRACT

One or more systems, devices, computer program products and/or computer-implemented methods of use provided herein relate to an intelligent and automated system to solve quantum computing related problems. The computer-implemented system can comprise a memory that can store computer-executable components. The computer-implemented system can further comprise a processor that can execute the computer-executable components stored in the memory, wherein the computer-executable components can comprise a recommendation component that can employ a machine learning model to generate, based on an input, a recommendation comprising a combination of entities comprising, one or more quantum circuits, one or more algorithms, one or more quantum hardware units, one or more error mitigation or error correction techniques, and one or more quantum procedures, to solve a defined problem comprised in the input.

### BACKGROUND

The subject disclosure relates to quantum computing, and more specifically to an intelligent and automated system to solve computational problems using quantum computation.

Quantum computing is generally the use of quantum-mechanical phenomena for the purpose of performing computing and information processing functions. Quantum computing can be viewed in contrast to classical computing, which generally operates on binary values with transistors. That is, while classical computers can operate on bit values that are either 0 or 1, quantum computers operate on quantum bits that comprise superpositions of both 0 and 1, can entangle multiple quantum bits, and use interference. Quantum computing techniques for solving computational problems can comprise combinations of algorithms, procedures, quantum hardware, and so on. Existing approaches can implement artificial intelligence (AI) in connection with classical computing to identify different techniques and benchmark the most optimal techniques for solving problems. However, existing approaches cannot automatically identify and benchmark optimal techniques comprising quantum computing features for solving a variety of computational problems.

The above-described background description is merely intended to provide a contextual overview regarding quantum computing and automatic identification of techniques involving quantum computing features and is not intended to be exhaustive.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable an intelligent and automated system for solving computational problems using quantum computation are discussed.

According to an embodiment, a system is provided. The system can comprise a memory that can store computer executable components. The system can further comprise a processor that can execute the computer executable components stored in the memory, where the computer executable components can comprise a recommendation component that can employ a machine learning model to generate, based on an input, a recommendation comprising a combination of entities comprising, one or more quantum circuits, one or more algorithms, one or more quantum hardware units, one or more error mitigation or error correction techniques, and one or more quantum procedures, to solve a defined problem comprised in the input. Such embodiments of the system can provide a number of advantages, including assisting researchers and practitioners with automating a discovery of solutions to problems (e.g., optimization problems, classification problems, etc.) by automatically identifying combinations of existing quantum algorithms, procedures, configurations, parameters, and hardware units that can be employed for solving the problems.

In one or more embodiments of the aforementioned system, a training component can train the machine learning model to generate the recommendation without executing the input on a quantum computing platform. In an aspect, training machine learning model can comprise performing a first stage of training by employing a training set comprising defined problems previously executed on quantum hardware and respective combinations of entities comprising quantum circuits, algorithms, quantum hardware units, error mitigation or error correction techniques, and quantum procedures, employed to execute the defined problems on the quantum hardware, to train the machine learning model, and employing a different machine learning model to generate new combinations of entities comprising the quantum circuits, the algorithms, the quantum hardware units, the error mitigation or error correction techniques, and the quantum procedures for the defined problems. In an aspect, training the machine learning model can comprise performing a second stage of training by employing the training set supplemented with the new combinations of entities and solutions generated by execution of the defined problems with the new combinations of entities as feedback information to retrain the machine learning model.

In one or more embodiments of the aforementioned system, the input can further comprise one or more datasets corresponding to the defined problem, and the combination of entities can further comprise parameters for solving the defined problem. In one or more embodiments of the aforementioned system, the recommendation component can recommend the combination of entities based on one or more constraints selected from a group comprising at least one of the one or more quantum circuits, the one or more algorithms, the one or more quantum hardware units, the one or more error mitigation or error correction techniques, the one or more quantum procedures, hybrid procedures and parameters. In one or more embodiments of the aforementioned system, an optimization component can apply various optimizations at an algorithm level, based on knowledge of techniques previously employed to solve the defined problem, to customize an algorithm of the one or more algorithms. In one or more embodiments of the aforementioned system, the recommendation component can recommend at least a second combination of entities to solve the defined problem, wherein the at least a second combination of entities can comprise additional or fewer entities than the combination of entities. In one or more embodiments of the aforementioned system, the combination of entities and the at least a second combination of entities can be executed in parallel on a quantum computing platform to generate respective results for the defined problem based on the combination of entities and the at least a second combination of entities. In one or more embodiments of the aforementioned system, an analysis component can analyze the respective results against evaluation metrics for the defined problem to identify an optimal combination of entities for solving the defined problem. Such embodiments of the system can provide a number of advantages, including assisting researchers and practitioners with automating a discovery of solutions to problems (e.g., optimization problems, computational problems, etc.) by automatically identifying combinations of existing quantum algorithms, procedures, configurations, parameters, and hardware units that can be employed for solving the problems, assisting one or more users with benchmarking how feasible different tasks can be based on an existing set of quantum computing-based resources, and assisting users in selection of error mitigation strategies that can be suitable for a problem provided by the users and a hardware preferred by the users.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can enable intelligent and automated recommendations of techniques based on quantum computing to solve problems in accordance with one or more embodiments described herein.

FIG. 2 illustrates another block diagram of an example, non-limiting system that can enable intelligent and automated recommendations of techniques based on quantum computing to solve problems in accordance with one or more embodiments described herein.

FIG. 3 illustrates a flow diagram of an example, non-limiting process of generating intelligent and automated recommendations of techniques based on quantum computing to solve problems in accordance with one or more embodiments described herein.

FIG. 4 illustrates a flow diagram of an example, non-limiting method for generating intelligent and automated recommendations of techniques based on quantum computing to solve problems in accordance with one or more embodiments described herein.

FIG. 5 illustrates a flow diagram of another example, non-limiting method for generating intelligent and automated recommendations of techniques based on quantum computing to solve problems in accordance with one or more embodiments described herein.

FIG. 6 illustrates a diagram of an example, non-limiting solution comprising an input and a corresponding output including a list of approaches that can be employed to solve a problem in the input in accordance with one or more embodiments described herein.

FIG. 7 illustrates a diagram of another example, non-limiting solution comprising an input and a corresponding output including a list of approaches that can be employed to solve a problem in the input in accordance with one or more embodiments described herein.

FIG. 8 illustrates a diagram of yet another example, non-limiting solution comprising an input and a corresponding output including a list of approaches that can be employed to solve a problem in the input in accordance with one or more embodiments described herein.

FIG. 9 illustrates a flow diagram of an example, non-limiting method that can enable intelligent and automated recommendations of techniques based on quantum computing to solve problems in accordance with one or more embodiments described herein.

FIG. 10 illustrates a flow diagram of an example, non-limiting method to train a machine learning model to generate intelligent and automated recommendations of techniques based on quantum computing to solve problems in accordance with one or more embodiments described herein.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

### Definitions

Program: A program is a piece of source code written in any language, specification, markup language, etc., expressing instructions to run in a unit with specific hardware capabilities.

Hardware unit: A hardware unit can be a quantum device, a quantum simulator, a part of the hardware or software composing or related to a quantum device, or any other system that can compute information using a specific hardware composition.

Many people often do not have the right knowledge for solving computational problem using quantum computing, without external help. For example, in certain situations, researchers and practitioners do not know what algorithms/procedures can be used to solve a specific task. This can be even more true with quantum computing, wherein one algorithm can run in different ways and the algorithm needs to be adapted for different hardware options available. Quantum computing techniques for solving computational problems can comprise combinations of algorithms, procedures, quantum hardware, and so on, and a single computational problem can be solved using multiple different techniques. Despite evolution in the integration of AI and quantum computing, much of existing research and development in the art is focused on designing new quantum algorithms for AI or mixing classical AI with quantum features to improve a specific domain or process, and a gap exists in applying machine learning and classical intelligence systems and algorithms to enhance quantum ecosystems and platforms, despite a demand in the quantum community.

Existing techniques generally explain how to operate quantum computers via different platforms, for example, by executing code on quantum computers using proxy platforms deployed on the cloud or generally in classical computers. Some existing techniques include different features such as optimization of execution, task scheduling on a quantum computing platform, testing of hardware using defined functions/code, using machine learning to improve executions in quantum computers, using hybrid mechanisms to find better solutions (for example in chemistry tasks), or improving hyperparameter selection in Quantum Machine Learning (QML) problems. For example, an existing technique can optimize and select the best hyperparameters for a particular QML problem under specific restrictions. However, the existing technique can offer the intelligent hyperparameter selection only for QML problems, wherein the existing technique can find the best hyperparameters to use when solving a problem with a particular QML algorithm based on restrictions (computational budget, ansatz to use, etc.).

In classical AI, some existing platforms can offer commercial products that can attempt to solve a specific problem using different approaches and benchmarking approaches to find optimal solutions, however such existing platforms do not include quantum features, quantum algorithms, intelligent code execution, optimization, and selection of hardware or error-related techniques for quantum computing. As such, none of the existing techniques provide an intelligent platform to solve quantum-related tasks using quantum hardware units, automatically and intelligently. Thus, an intelligent platform that can assist users to test data and requirements, and that can assist users to find the most suitable algorithms and procedures for a specific hardware to accomplish a task using quantum computing can be desirable.

Various embodiments of the present disclosure can be implemented to produce a solution to these problems. Embodiments described herein include systems, computer-implemented methods, and computer program products that can provide an intelligent platform that can identify the most appropriate combinations of quantum circuits, quantum hardware units, error mitigation techniques, error correction techniques or error suppression techniques, algorithms, procedures, and parameters that can be employed to execute a process of solving a problem. For example, based on a user-defined task, data provided by a user in connection with the user-defined task and one or more constraints (use of specific hardware, noise mitigation, algorithms, properties, metric to evaluate solutions, etc.) specified by the user, the intelligent platform can benchmark how a solution to the user-defined task can be reached using one or more combinations of different algorithms, parameters, data, quantum procedures, hardware units and error mitigation techniques. In various embodiments, the intelligent platform can be applicable for general usage without being restricted QML/QML problems. In various embodiments, the intelligent platform can consider hyperparameters and algorithms while identifying potential combinations of entities for solving the user-defined task, and the intelligent system can also identify the best quantum hardware and/or error-related techniques to employ to solve the user-defined task. Test results generated by executing the potential combinations of entities on a quantum computing platform can be provided to the user on real devices (e.g., a computer, laptop, etc.). It is to be appreciated that, in the various embodiments, noise mitigation has been mentioned for the sake of brevity, however, noise mitigation, cancellation, suppression and corrections techniques can generally be considered.

In various embodiments, the intelligent platform can be an intelligent system that can use quantum computing algorithms and procedures to solve user-defined tasks/problems based on data inputs and constraints or requirements provided by a user, and further based on existing knowledge of prior procedures used to solve the user-defined tasks/problems. In various embodiments, the intelligent system can attempt to solve a problem while benchmarking different possible techniques respectively comprising different combinations of entities (e.g., algorithms, procedures, quantum hardware units, etc.). For example, users can submit data based on observations (or use pre-defined datasets) and a problem to solve (optimization problem, classification problem, etc.) from a catalog via an application programming interface (API) or a user interface (UI) to the intelligent system. As part of inputs to the intelligent system, users can introduce constraints comprising a family of pre-defined algorithms to use or specific pre-defined algorithms to employ for generating solutions to the problem, user-defined algorithms to be tested, specific quantum procedures or hybrid (quantum & classical) procedures, ranges or specific values for algorithm parameters or procedure parameters, metrics for evaluation of the results, hardware specifications to be considered or hardware restrictions to be met for solving a problem, quantum properties to be considered for solving a problem, a shots limit for error-related techniques, a desired output quality for error-related techniques, and/or any other relevant restriction or constraint. The intelligent system can analyze the inputs from the users to identify one or more combinations of entities that can be implemented for solving the problem, and the intelligent system can return to the user, a set of results based on the one or more combinations of entities.

In various embodiments, the one or more combinations of entities can comprise combinations of algorithms, procedures, parameters, quantum hardware units, quantum circuits, etc., used to discover solutions to the problem. For example, the intelligent system can select a quantum processing unit (QPU) in combination with the intelligent selection of the algorithm, error-related strategy, and other entities/procedures needed to solve the task. The results returned to the user can include evaluations of results generated by execution of the combinations of entities identified by the intelligent system on a quantum computing platform based on pre-defined or user-defined metrics. The intelligent system can allow the user to see different potential solutions to a problem and how the different potential solutions can behave (including configurations, etc.) in comparison to one another. Thus, the various embodiments herein can address the entire cycle of life of a problem and solve the problem completely, as opposed to only selecting the right code implementation for an algorithm and running the right code implementation.

In various embodiments, the user or the intelligent system can define the maximum number (max N) of combinations to employ while benchmarking potential solutions. If the type of algorithms or procedures to use are not restricted or defined by the user, the intelligent system can determine algorithms that can be employed to better solve the problem. Likewise, if the values or potential ranges of values for algorithm parameters are not restricted by the user, the intelligent system can use random parameters, use values based on previous executions or apply intelligent (machine learning/neural algorithm or recommender systems) or brute force-based solutions to determine the algorithm parameters. Further, the intelligent system can select whether the solutions can be purely quantum or hybrid (quantum and classical). The intelligent system can select the solutions based on outputs from machine learning/neural algorithms or recommender systems that can learn from previous executions. If the user does not restrict the specific quantum hardware to be employed or properties of a quantum hardware to be considered by the intelligent system, the intelligent system can use generic hardware or any suitable hardware, depending on the problem to solve, data to use, or any other user-defined condition. The selection of the hardware can be made by the intelligent system based on intelligent algorithms/procedures such as those previously described.

Various embodiments herein can provide an intelligent system that can provide improvements to a quantum computing platform. For example, the intelligent system can assist researchers to discover new ways of solving quantum-computing related tasks and to test different combinations of algorithms, parameters, procedures, and hardware to solve problems and find optimal solutions that can improve upon existing solutions. Further, the intelligent system can help practitioners test different solutions and understand how various procedures, hardware units, and algorithms can affect problem solutions and discover new ways of solving quantum-computing related tasks. Further still, various embodiments of the present disclosure can assist researchers and practitioners with automating a discovery of solutions to problems (e.g., optimization problems, classification problems, etc.) based on combinations of existing quantum algorithms, procedures, configurations, parameters, and hardware units, benchmarking how feasible different tasks can be based on an existing set of quantum-related resources, and selecting error-related strategies that can be suitable for a problem provided by the user and a hardware specified by the user.

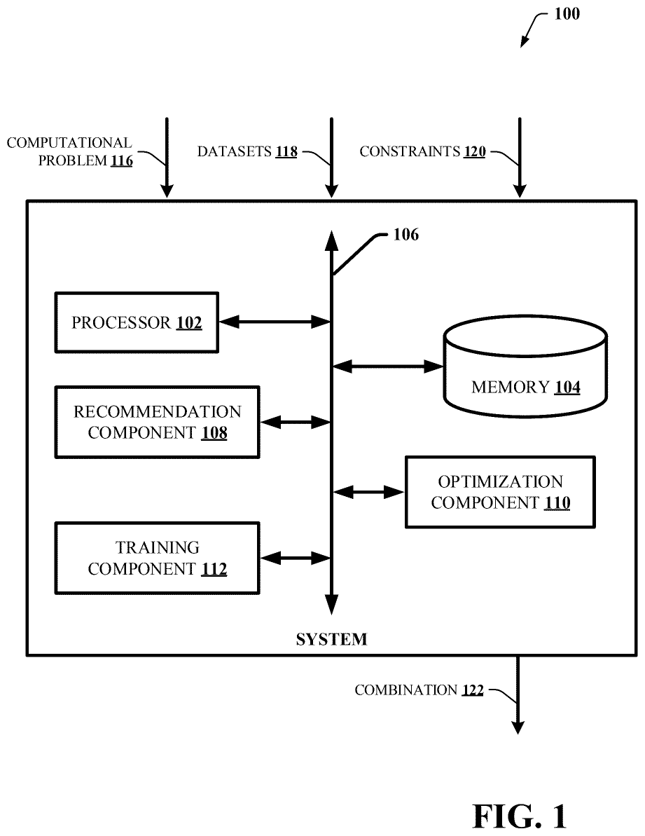

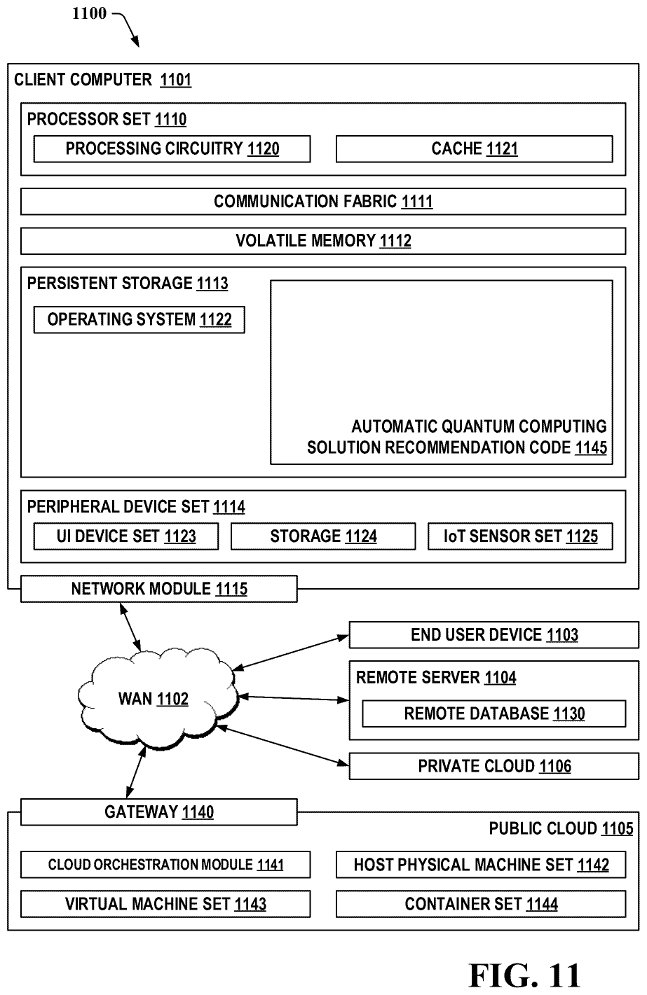

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 (e.g., system 100) as illustrated at FIG. 1, and/or systems thereof, can further comprise, be associated with and/or be coupled to one or more computer and/or computing-based elements described herein with reference to an operating environment, such as the operating environment 1100 illustrated at FIG. 11. For example, system 100 can be associated with, such as accessible via, a computing environment 1100 described below with reference to FIG. 11, such that aspects of processing can be distributed between system 100 and the computing environment 1100. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can enable intelligent and automated recommendations of techniques based on quantum computing to solve problems in accordance with one or more embodiments described herein.

System 100 and/or the components of system 100 can be employed to use hardware and/or software to solve problems that are highly technical in nature (e.g., related to quantum computing, intelligent and automatic recommendation of quantum computing techniques for solving computational problems, etc.), that are not abstract and that cannot be performed as a set of mental acts by a human. Further, some of the processes performed may be performed by specialized computers for carrying out defined tasks related to the intelligent and automatic recommendation of quantum computing techniques for solving computational problems. The system 100 and/or components of the system can be employed to solve new problems that arise through advancements in technologies mentioned above, quantum computing, and/or the like. The system 100 can provide technical improvements in terms of finding combinations of procedures and algorithms that can improve efficiency of solving a problem such as, for example, an optimization problem, classification problem, etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., recommendation component 108, optimization component 110, and/or analysis component 214) to perform one or more actions. In one or more embodiments, memory 104 can store computer-executable components (e.g., recommendation component 108, optimization component 110, and/or analysis component 214).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

As described above, in addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, recommendation component 108 can employ a machine learning model to automatically generate, based on an input, a recommendation comprising a combination of entities (e.g., combination 122) comprising one or more quantum circuits, one or more algorithms/computing algorithms, one or more quantum hardware units, one or more error mitigation or error correction techniques, and one or more quantum procedures, to solve a defined problem (e.g., computational problem 116) comprised in the input. It is to be appreciated that the combination of entities (e.g., combination 122) can comprise error mitigation, error correction, error cancelation or any other error reduction or removal technique. In an aspect, the input can comprise the defined problem and one or more datasets corresponding to the defined problem, and the combination of entities can further comprise parameters for solving the computational problem 116. For example, a user can input computational problem 116 and datasets 118 via an API or a UI to system 100. In an embodiment, the user can be a human user, whereas in other embodiments, user 302 can be a hardware, software, machine, or AI.

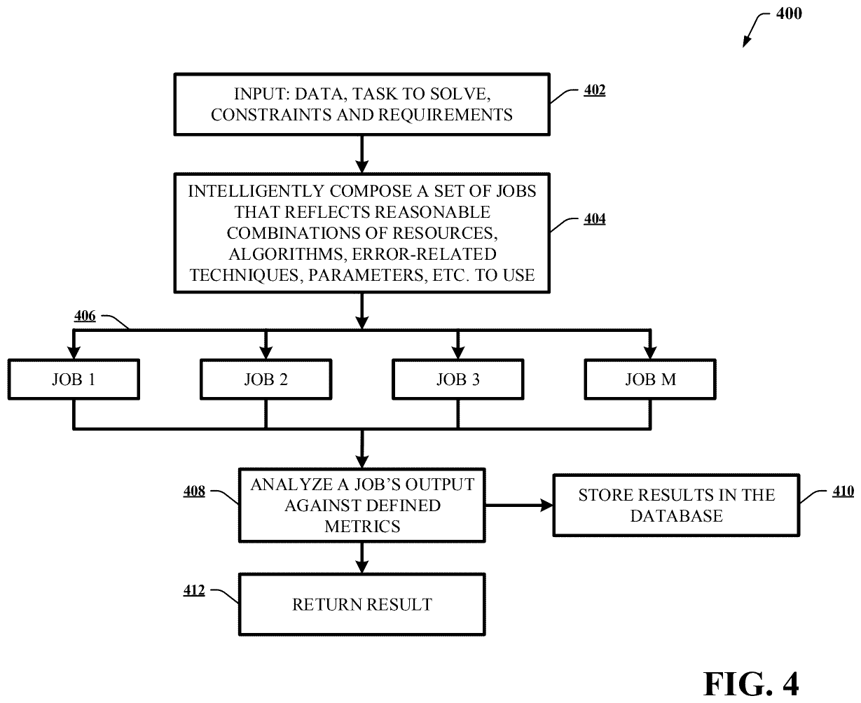

In various embodiments, the machine learning model can specify the quantum hardware, qubits, entanglements, and other aspects that can be employed to solve computational problem 116. For example, in an embodiment, the machine learning model can specify a quantum hardware and the number of qubits of the quantum hardware that can be employed to solve computational problem 116. In another embodiment, the machine learning model can specify more than one quantum hardware and the number of qubits on each quantum hardware that can be employed to solve computational problem 116. In yet another embodiment, the machine learning model can specify the number of logical and/or physical qubits on one or more quantum hardware that can be employed to solve computational problem 116. In some embodiments, the machine learning model can also define one or more quantum circuits and quantum gates that can be employed to computational problem 116. The machine learning model can define such specifications for one or more defined problems such as computational problem 116. The machine learning model can be trained by training component 112 as explained infra with reference to FIG. 4.

In various embodiments, recommendation component 108 can employ the machine learning model to generate a plurality of combinations of entities (e.g., a plurality of combinations 122) comprising one or more quantum circuits, one or more algorithms/computing algorithms, onc or more quantum hardware units, one or more error mitigation or error correction techniques, and one or more quantum procedures, to solve the defined problem (e.g., computational problem 116), and recommendation component 108 can execute the combinations of entities. For example, recommendation component 108 can configure quantum systems according to the different combinations of entities generated by the machine learning model to generate different results for computational problem 116. For example, recommendation component 108 can execute at least a first combination of quantum circuits, quantum hardware units, algorithms, error mitigation or error correction techniques, quantum procedures and/or other computational aspects. Prior to executing such combinations, recommendation component 108 can configure each entity to the specification generated by the machine learning component. For example, recommendation component 108 can organize quantum circuits, configure quantum hardware units, modify quantum algorithms, apply appropriate error mitigation techniques and quantum procedures, and so on, according to the first combination of such entities to generate a solution to computational problem 116. Thus, recommendation component 108 can generate respective solutions for computational problem 116 according to the respective combinations of entities generated by the machine learning model, and organize the respective solutions according to the performance metric prior to outputting the respective solutions at a UI. In various embodiments, recommendation component 108 can configure respective quantum systems according to all the combinations of entities generated by the machine learning model, to execute the combinations of entities and produce respective solutions to computational problem 116.

Computational problem 116 can be a task to be solved, such as an optimization problem, classification problem, etc., for which the user desires to find a solution, and the user can select the task from a catalog comprising a pre-defined list of tasks. Based on the advancements in quantum computing technologies and availability of state-of-the-art quantum computing, the pre-defined list can grow over time. Datasets 118 can comprise pre-defined datasets related to computational problem 116. For example, computational problem 116 can be a classification problem, and there can be various data points associated with computational problem 116, wherein the data points can be provided to system 100 as datasets 118. In an embodiment, datasets 118 can comprise one or more datasets based on observations of the user provided to system 100 by the user or datasets 118 can be from a public repository or a predefined dataset provided to system 100 by the user. In another embodiment, datasets 118 can comprise one or more datasets internal to system 100 and accessible to system 100 through a database. In yet another embodiment, system 100 can access datasets 118 from another location/existing datasets. Generally, datasets 118 can comprise observations of the user or data from public repositories provided to system 100 by the user.

In an aspect, recommendation component 108 can recommend the combination of entities (e.g., combination 122) based on one or more constraints selected from a group comprising at least one of the one or more quantum circuits, the one or more algorithms, the one or more quantum hardware units, the one or more error mitigation techniques, the one or more quantum procedures, hybrid procedures and parameters. For example, a user can input computational problem 116 and datasets 118 via an API or a UI to system 100, and the user can additionally or optionally input constraints 120 into system 100 via the API or the UI. Constraints 120 can comprise one or more specifications such as procedures, hardware, algorithms, error-related techniques, metrics, constraints, etc. that the user can specify to system 100 for generating solutions to computational problem 116. That is, constraints 120 can comprise constraints introduced by the user for system 100 to consider when generating approaches to solve computational problem 116. For example, constraints 120 can comprise a family of pre-defined algorithms or specific pre-defined algorithms, user-defined algorithms to test, specific quantum or hybrid (e.g., quantum and classical) procedures, ranges or specific values for algorithms, procedures or parameters, metrics for evaluation of approaches identified by system 100 to solve computational problem 116, specific hardware to be employed or hardware restrictions to be met for identifying the approaches, quantum properties to be considered for identifying the approaches, shots limit for error-related techniques, a desired output quality for the error-related techniques, and/or any other relevant restrictions or constraints. For example, as discussed elsewhere herein, the user can request to receive a desired quality of results, a maximum number of shots or a maximum execution time. For example, the user can specify an error percentage (%) limit on an observable. In an embodiment, the user can input only datasets 118 and computational problem 116 to a UI associated with system 100, without specifying constraints 120, and system 100 can identify the best solutions (e.g., combinations of entities for solving computational problem 116 via quantum (i.e., quantum computing) or hybrid (i.e., quantum and classical computing) procedures) based only on computational problem 116 and datasets 118.

As discussed above, recommendation component 108 can employ a machine learning model to recommend the combination of entities (e.g., combination 122) based on prior knowledge of techniques previously employed to solve computational problem 116. For example, the input provided by the user to system 100 can be sent to an API of system 100. The API of system 100 can order an intelligent composer (e.g., recommendation component 108) to check for existing knowledge of computational problems and combinations of entities previously employed in connection with the computational problems. Recommendation component 108 can check for the existing knowledge using a set of predefined entities in system 100, wherein the set of predefined entities can represent a set of predefined tasks, existing algorithms, procedures, error-related techniques, metrics, constraints, properties, available hardware, etc. that can be retrieved from a database accessible to system 100. The API can order recommendation component 108 to identify/define, based on information from the set of predefined entities, combinations of entities (e.g., algorithms, hardware units, error-related techniques, etc.) that can be employed to solve computational problem 116. In other words, recommendation component 108 can receive from the API, the input (e.g., computational problem 116, datasets 118 and/or constraints 120) provided by the user, wherein based on the input, recommendation component 108 can check for existing knowledge related to the input, and wherein based on the existing knowledge, recommendation component 108 can recommend the best combinations of entities to solve computational problem 116. As stated elsewhere herein, the existing knowledge can refer to prior knowledge of tasks, algorithms, procedures, parameters, etc. that can be stored in a database accessible by system 100.

In an aspect, recommendation component 108 can recommend at least a second combination of entities to solve computational problem 116, wherein the at least a second combination of entities can comprise additional or fewer entities than the combination of entities. In various embodiments, recommendation component 108 can recommend the combination of entities (e.g., combination 122) and the at least a second combination of entities based on computational problem 116, datasets 118 and constraints 120, as well as, existing knowledge of the potential techniques employed during prior executions of problems, accessible to system 100. In various embodiments, recommendation component 108 can recommend the combination of entities (e.g., combination 122) and the at least a second combination of entities based on computational problem 116, datasets 118, and, existing knowledge of the potential techniques employed during prior executions of problems, accessible to system 100.

In an embodiment, optimization component 110 can apply various optimizations at an algorithm level, based on knowledge of techniques previously employed to solve computational problem 116, to customize an algorithm of the one or more algorithms. For example, system 100 can apply different optimizations (e.g., via optimization component 110) at the code level, based on the prior knowledge, to improve the potential combinations of entities (e.g., by using machine learning, neural networks, etc.). Similarly, system 100 can automatically (and intelligently) enhance a compilation to customize a code for specific hardware, etc. Further, system 100 can learn about the potential combinations of entities, applicability of the potential combinations of entities to different quantum hardware devices, quantum constraints and features of the potential combinations of entities. In various embodiments, based on availability of hardware, noise properties of the hardware and results of previous executions, system 100 can choose to run on a specific backend with a specific error mitigation algorithm. For example, some problems need to be executed on low noise hardware while other problems can be more resilient to noise, and system 100 can choose a backend accordingly.

In an embodiment, the combination of entities and the at least a second combination of entities can be executed in parallel on a quantum computing platform to generate respective results for computational problem 116 based on the combination of entities and the at least a second combination of entities. For example, the input provided by the user can be received by the API of system 100 that can send the input to recommendation component 108. Recommendation component 108 can return to the API, a set of combinations of entities (e.g., algorithms, procedure, quantum hardware units, etc.) that can be potentially employed to solve computational problem 116, for testing. The set of combinations of entities can comprise the top N combinations of entities identified by an algorithm of recommendation component 108, wherein N can be a positive integer. In other words, the set of combinations of entities can comprise a number of combinations of entities having respective performance values higher than a threshold after execution of the combinations of entities on quantum hardware followed by analysis of the results of the execution by system 100 against a performance metric. For example, the API of system 100 can send to an API of a quantum computing platform (e.g., quantum computing platform API), the set of combinations of entities as a set of jobs that the quantum computing platform can execute. The quantum computing platform can execute respective combinations of entities as respective jobs to test for issues that the respective combinations of entities can have. The quantum computing platform can execute the respective jobs in parallel. For example, the quantum computing platform API can receive the jobs to be executed and input the jobs to a queue. From the queue, the jobs can be received by a dispatcher, and the dispatcher can send the jobs to quantum units for execution. The quantum units can comprise quantum devices and simulators, and the jobs can be executed on real quantum hardware or on simulators. After execution of the jobs by the quantum units, the results of the execution can be returned to the quantum computing platform API, and the quantum computing platform API can save the results to a database of the quantum computing platform and provide the results to the API of system 100. The API of system 100 can return to the user, the best results (e.g., top 3 combinations of entities, top 10 combinations of entities, etc.) based on a performance metric.

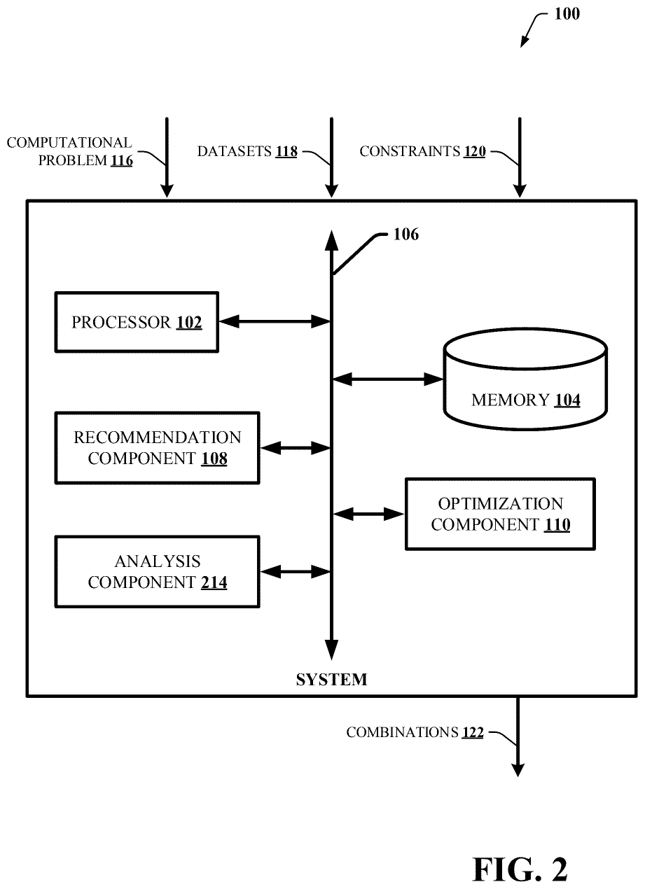

FIG. 2 illustrates another block diagram of the example, non-limiting system 100 that can enable intelligent and automated recommendations of techniques based on quantum computing to solve problems in accordance with one or more embodiments described herein. Repetitive description of like elements and/or processes employed in respective embodiments is omitted for sake of brevity.

With continued reference to FIG. 1, system 100 can further comprise analysis component 214. In an embodiment, analysis component 214 can analyze respective results generated by execution of different combinations of entities (e.g., quantum algorithms, quantum hardware units, procedures, etc.), identified by recommendation component 108 for solving computational problem 116, on a quantum computing platform. Analysis component 214 can analyze the respective results against evaluation metrics for computational problem 116 to identify an optimal combination of entities for solving computational problem 116. For example, based on computational problem 116, datasets 118, existing knowledge of known problems and techniques used for solving the known problems and/or constraints 120, system 100 can define a set of jobs that can be tested as potential best approaches to generate a solution to computational problem 116. Analysis component 214 can analyze results of respective jobs of the set of jobs against defined metrics. The results can be stored in a database and returned to the user.

In various embodiments, the user can specify a performance metric to be used by system 100 to identify and return to the user, the best combination of entities (e.g., N best combinations of entities) for solving computational problem 116, by analyzing the respective results. For example, the user can specify to system 100 to find the best solution based on fidelity for an algorithm. Fidelity is a metric in quantum computing that can be used to check how far a solution is from an ideal result. Error-based metrics can also be employed for analyzing the respective results. For example, the user can specify to system 100 to find the best solution based on average error, etc. In this case, error-mitigation can be a part of the procedure. However, if no performance metric is specified by the user, system 100 can automatically decide upon the best performance metric to use to analyze the respective results from an existing knowledge base. For example, system 100 can analyze the input provided by the user to system 100 to identify metrics previously employed by system 100 for other jobs. The selection of the metric can be based on rules. Additional aspects of the various embodiments herein are disclosed with reference to subsequent figures.

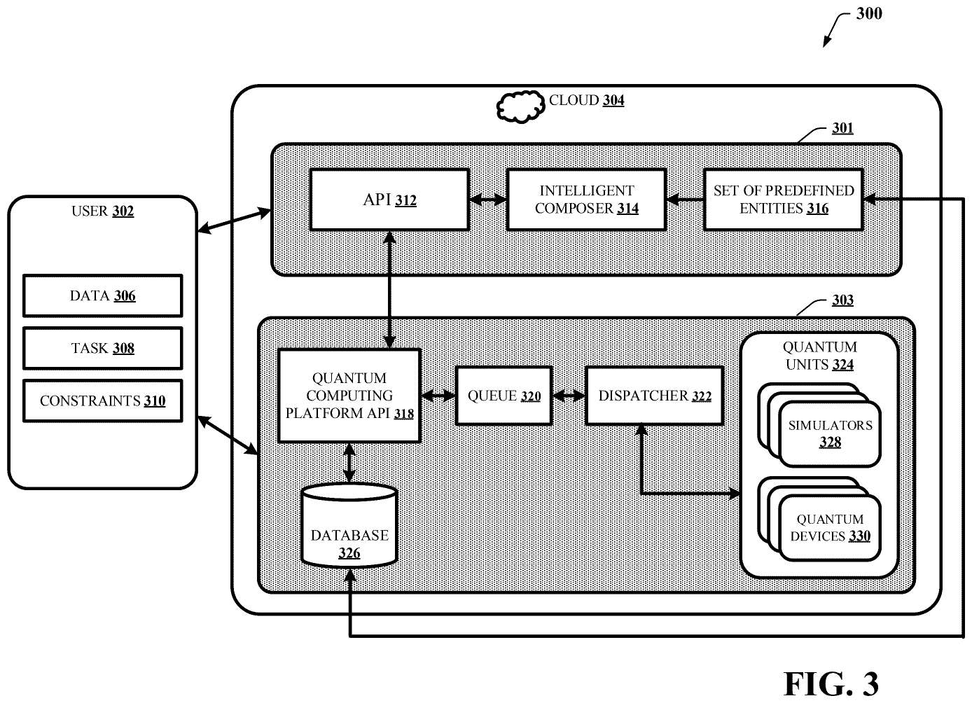

FIG. 3 illustrates a flow diagram of an example, non-limiting process 300 of generating intelligent and automated recommendations of techniques based on quantum computing to solve problems in accordance with one or more embodiments described herein. One or more operations described with respect to FIG. 3 can be performed by one or more components of system 100 of FIGS. 1 and 2. Repetitive description of like elements and/or processes employed in respective embodiments is omitted for sake of brevity.

In various embodiments, an intelligent platform can benchmark how a solution to a defined task can be reached using one or more combinations of algorithms, parameters, data, quantum procedures, quantum circuits, quantum hardware units and error mitigation techniques, based on an input comprising a defined task, datasets, and additionally or optionally, constraints specifying a quantum hardware, noise mitigation techniques, algorithms, properties, metrics for evaluating results in connection with the defined task, and/or other constraints. For example, user 302 can input or submit data 306, task 308, and additionally or optionally, constraints 310 via an API or a UI to a system (e.g., system 100) that can provide the intelligent platform illustrated at 301.

In various embodiments, task 308 can be a task to be solved, and task 308 can comprise a problem (e.g., computational problem 116) such as an optimization problem, classification problem, etc. for which user 302 desires to find a solution. User 302 can select the task 308 from a catalog comprising a pre-defined list of tasks. Based on advancements in quantum computing technologies and availability of state-of-the-art quantum computing, the pre-defined list of tasks can grow over time. Data 306 can comprise pre-defined datasets related to task 308. For example, task 308 can be a classification problem for classifying flowers based on observations of the flower (e.g., identifying a flower based on an image), and there can be different data/data points associated with task 308, wherein the data/data points can be provided to the system as data 306. In an embodiment, data 306 can comprise a dataset based on observations of user 302 provided to the system by user 302 or a dataset from a public repository or a predefined dataset provided to the system by user 302. In another embodiment, data 306 can comprise a dataset from the system or accessible to the system. For example, database 326 can comprise example datasets, including data 306, and the system can access data 306 from database 326 or ingest data 306 from another location/existing datasets. Generally, data 306 can comprise observations of user 302 or data from public repositories provided to the system by user 302.

In various embodiments, constraints 310 can comprise specifications such as procedures, hardware, algorithms, error-related techniques, metrics, constraints, etc. that user 302 can specify to the system for generating solutions to task 308. For example, constraints 310 can comprise specifications introduced by user 302, such as, a family of pre-defined algorithms to employ or specific pre-defined algorithms to employ for generating approaches to solve task 308, user-defined algorithms to test, specific quantum procedures or hybrid (e.g., quantum and classical) procedures, ranges or specific values for algorithms, procedures or parameters, metrics for evaluation of approaches identified by the system to solve task 308, specific hardware to be employed or hardware restrictions to be met, quantum properties to be considered, shots limit for error-related techniques, a desired output quality for the error-related techniques, and/or any other relevant restrictions or constraints. In an embodiment, user 302 can input only data 306 and task 308 to the UI associated with the system (e.g., system 100) without specifying constraints 310, and the system can identify the best solutions based only on data 306 and task 308, by employing knowledge of existing problems and techniques previously employed by the system to solve the existing problems, via machine learning.

Thus, user 302 can input data 306 and task 308 to the system (e.g., system 100), and user 302 can additionally or optionally input constraints 310 to the system, wherein the system can provide an intelligent platform that can benchmark how a solution to task 308 can be reached using one or more combinations of algorithms, parameters, data, quantum procedures, quantum circuits, quantum hardware units, error mitigation techniques and other quantum features, based on the input by user 302. The system can be deployed via cloud 304 (e.g., a cloud environment). The system can comprise API 312 (e.g., an API of the intelligent platform) that can facilitate communications between the system and users of the system (e.g., through a UI) or between the system and other platforms such as, for example, the quantum computing platform illustrated at 303. The intelligence platform can interact with the quantum computing platform to identify various combinations of entities that can be employed to solve task 308. The quantum computing platform can also be accessible through cloud 304.

The system can further comprise intelligent composer 314 (e.g., recommendation component 108) that can define sets of quantum jobs, wherein each quantum job can represent a combination of entities comprising a variety of algorithms, procedures, constraints, properties, quantum hardware, and so on, that can be executed to solve task 308. In one or more embodiments, intelligent composer 314 can be an orchestrator that can benchmark the various combinations of algorithms, parameters, quantum hardware units, quantum circuits, etc. Set of predefined entities 316 can represent a set of predefined tasks, existing algorithms, procedures, error-related techniques, metrics, constraints, properties, available hardware, etc. that can be retrieved from database 326, wherein database 326 can be an existing database comprising the predefined tasks, the existing algorithms, the procedures, the error-related techniques, the metrics, the constraints, the properties, the available hardware, etc. Intelligent composer 314 can use information from set of predefined entities 316 to correctly identify one or more combinations of entities (e.g., algorithms, hardware, procedures, etc.) that can be tested to identify the best techniques (e.g., top 3 combinations, top 10 combinations, etc.) that can be implemented for solving task 308 based on a performance metric.

In an embodiment, input provided by user 302 at the UI can be sent to API 312. API 312 can order intelligent composer 314 to check for existing knowledge of tasks and combinations of entities employed in connection with the tasks, using set of predefined entities 316, and API 312 can order intelligent composer 314 to identify/define, based on information from set of predefined entities 316, combinations of entities (e.g., quantum algorithms, quantum hardware units, error-related techniques, etc.) that can be employed to solve task 308. In other words, intelligent composer 314 can receive from API 312, the input (e.g., data 306, task 308 and/or constraints 310) provided by user 302, wherein based on the input, intelligent composer 314 can check for existing knowledge related to the input, and wherein based on the existing knowledge, intelligent composer 314 can recommend different combinations of entities to solve task 308. As stated elsewhere herein, the existing knowledge can refer to prior knowledge of tasks, algorithms, procedures, parameters, etc. that can be stored in database 326 and accessible to the system through set of predefined entities 316. For example, based on the existing knowledge, the system can know that for problem A, a solution B was employed in the past.

In an embodiment, intelligent composer 314 can be a recommendation system that can use machine learning to provide the recommendations. That is, the intelligent composer 314 can be a recommendation engine that can identify potential combinations of entities having a probability greater than a threshold to solve task 308, based on the input from user 302 and prior knowledge of known tasks and techniques or procedures previously employed in connection with the known tasks. In various embodiments, the threshold can be defined by N best recommendations, wherein intelligent composer 314 can comprise an algorithm that can automatically generate the N best recommendations for task 308, wherein N can be a positive integer. In some embodiments, for example, in cases of well-known tasks, the threshold of probability can be defined, whereas in other embodiments, for examples, in cases of unknown tasks, defining the probability can be challenging from a perspective of user 302. The algorithm employed by intelligent composer 314 can be a known algorithm such as, for example, based on machine learning-based recommendation engines or other systems that can decide rules according to data.

After initial recommendations from intelligent composer 314, the system can enable execution of the recommendations on the quantum computing platform. Thereafter, the system can present to user 302, the tested recommendations and information about algorithms, procedures, parameters, and other entities employed for testing respective recommendations, as a list of solutions that user 302 can select from to solve task 308. The intelligent platform (e.g., illustrated at 301) can interact with the quantum computing platform (e.g., illustrated at 303) in two ways that can represent communication focal points. For example, the intelligent platform can interact with database 326 to acquire information about known tasks and combinations of entities, and API 312 can interact with quantum computing platform API 318 to send a set of quantum jobs to be executed to quantum computing platform API 318, wherein the set of jobs can represent respective combinations of entities identified by intelligent composer 314 for solving task 308, and wherein the quantum computing platform can run the set of jobs. In various embodiments, API 312 can send the set of jobs to quantum computing platform API 318 to verify that the recommendation generated by intelligent composer 314 is correct and send the recommendations to user 302 based on the results.

In various embodiments, user 302 can receive at a device (e.g., a user device such as a computer, laptop, etc. with a UI), a list of recommendations made by intelligent composer 314 after all jobs have been run by quantum computing platform API 318. For example, user 302 can input data 306, task 308, and additionally or optionally, constraints 310 into the system (e.g., system 100) via a UI, and the input can be received by API 312 that can send the inputs to intelligent composer 314. Intelligent composer 314 can return to API 312, a set of combinations of entities (e.g., quantum algorithms, procedures, quantum hardware units, etc.) that can be potentially employed to solve task 308, for testing. As stated elsewhere herein, the set of combinations of entities can comprise the top N combinations of entities identified by an algorithm of intelligent composer 314. API 312 can send the set of combinations of entities to quantum computing platform API 318 as a set of jobs that the quantum computing platform can execute for solving task 308. The quantum computing platform can execute respective combinations of entities as respective jobs and test for issues that the respective combinations of entities can have when employed for solving task 308. The quantum computing platform can execute the respective jobs in parallel. For example, quantum computing platform API 318 can receive the jobs to be executed and input the jobs to queue 320, queue 320 can forward the jobs to dispatcher 322 that can send the jobs to quantum units 324 for execution. Quantum units 324 can comprise simulators 328 and quantum devices 330 that can execute the jobs. After execution of the jobs by quantum units 324, the results of the execution can be returned to quantum computing platform API 318. Quantum computing platform API 318 can save the results to database 326 and send the results to API 312. API 312 can return to user 302, the X number of best results (e.g., 5 best results, 10 best results, etc.) or top N combination of entities according to a performance metric (e.g., fidelity, etc.), wherein X and N can be positive integers.

In an embodiment, the X number of best results based on tests run by the quantum computing platform in connection with the set of jobs can be returned from API 312. In another embodiment, the X number of best results can be returned from quantum computing platform API 318 to user 302. In case of quantum computing platform API 318, the results can be directly returned to user 302, instead of the results being first sent to API 312. In various embodiments, API 312 can originate from one provider or company and quantum computing platform API 318 can be from another provider or company. Thus, while user 302 can interact with the intelligent platform to input information to the system (e.g., system 100), depending on security reasons or legal reasons, user 302 can desire to receive results directly from the quantum computing platform (e.g., quantum computing platform API 318) as opposed to the intelligent platform (e.g., API 312).

In various embodiments, the system can return the X number of best results according to a quality or a metric defined by user 302 in the inputs. For example, based on the combination of data 306 and task 308, the system can define a set of jobs that can be tested as potential best approaches to generate a solution to task 308, and the system (e.g., analysis component 214) can analyze results of respective jobs of the set of jobs against defined metrics to assess performance of the various combinations of entities identified by intelligent composer 314 in solving task 308. The results can be stored in database 326 and returned to user 302. In various embodiments, intelligent composer 314 can return the X number of best results even if intelligent composer 314 can identify more than X number of best results as potential combinations of entities that can be employed to solve task 308. Additional aspects of the intelligent platform discussed in various embodiments are disclosed with reference to subsequent figures.

FIG. 4 illustrates a flow diagram of an example, non-limiting method 400 for generating intelligent and automated recommendations of techniques based on quantum computing to solve problems in accordance with one or more embodiments described herein. One or more operations described with respect to FIG. 4 can be performed by one or more components of system 100 of FIGS. 1 and 2. Repetitive description of like elements and/or processes employed in respective embodiments is omitted for sake of brevity.

In an embodiment, a system (e.g., system 100) can benchmark how a solution to a defined task can be reached using one or more combinations of algorithms, parameters, data, quantum procedures, quantum circuits, quantum hardware units and error mitigation techniques, based on an input comprising a defined task, datasets, and additionally or optionally, constraints specifying a quantum hardware, noise mitigations techniques, algorithms, properties, metrics for evaluating solutions, and/or other constraints.

In an embodiment, the system (e.g., system 100) can be a machine learning recommender system that can comprise a machine learning model that can learn over time from previous executions of combinations of entities employed to solve problems. The training of the system can comprise using past executions of techniques on real quantum hardware, comprising pairs of user inputs and corresponding outcomes achieved, based on a given performance metric, for the system to learn to estimate a new input based on a performance metric without having to execute it. Once trained, the machine learning model can estimate the performance metric for all or a subset of possible algorithms and hardware and select the best candidates for execution on the real quantum hardware, in response to the user or another user submitting new inputs. The training of the machine learning model can be performed periodically to keep the machine learning model up to date with new data received from recent executions (e.g., executions performed within a specific time interval) on real quantum hardware.

For example, with continued reference to FIG. 1, recommendation component 108 can employ a machine learning model that can generate, based on an input, a recommendation comprising a combination of entities comprising one or more quantum circuits, one or more computing algorithms, one or more quantum hardware units, one or more error mitigation or error correction techniques, and one or more quantum procedures, to solve computational problem 116 comprised in the input. In various embodiments, training component 112 can train the machine learning model to generate the recommendation without executing the input on the quantum computing platform. For example, training component 112 can perform a first stage of training by employing a training set comprising defined problems previously executed on quantum hardware and respective combinations of entities comprising quantum circuits, algorithms, quantum hardware units, error mitigation or error correction techniques, and quantum procedures, employed to execute the defined problems on the quantum hardware, to train the machine learning model. After training the machine learning model, a different machine learning model can be employed to generate new combinations of entities comprising the quantum circuits, the algorithms, the quantum hardware units, the error mitigation or error correction techniques, and the quantum procedures for the defined problems upon training. Thereafter, training component 112 can perform a second stage of training by employing the training set supplemented with the new combinations of entities and with solutions generated by execution of the defined problems with the new combinations of entities as feedback information to retrain the machine learning model employed by recommendation component 108. For example, the new combinations of entities and solutions generated by employing the new combinations of entities to solve the defined problems previously executed on quantum hardware can be employed by training component 112 to update parameters of the machine learning model employed by recommendation component 108 to generate a new version of the machine learning model. Thus, training component 112 can perform a multistage training of the machine learning model. Training component 112 can train the machine learning model prior to the machine learning model being deployed to generate the recommendations.

At 402 of the non-limiting method 400, a user (e.g., user 302 of FIG. 3) can input data (e.g., data 306 of FIG. 3), a task to solve (e.g., task 308 of FIG. 3) and constraints or requirements (e.g., constraints 310) into a system (e.g., system 100) for solving the task. As discussed above, the task can be a task to be solved, and the task can comprise a problem (e.g., computational problem 116) such as an optimization problem, classification problem, etc. for which the user desires to find a solution. The user can select the task from a catalog comprising a pre-defined list of tasks. Based on advancements in quantum computing technologies and availability of state-of-the-art quantum computing, the pre-defined list can grow over time. The data can comprise pre-defined datasets related to the task. For example, the task can be a classification problem for classifying flowers based on observations of the flower (e.g., identifying a flower based on an image), and there can be different data/data points associated with the task, wherein the data/data points can be provided to the system by the user or accessed by the system from a database connected to the system.

As further discussed above, the constraints (or requirements) can comprise specifications such as procedures, hardware, algorithms, error-related techniques, metrics, constraints, etc. that the user can specify to the system for generating solutions to the task. For example, the constraints can comprise constraints introduced by the user, such as a family of pre-defined algorithms to employ or specific pre-defined algorithms to employ for generating approaches to solve the task, user-defined algorithms to test, specific quantum or hybrid (e.g., quantum and classical) procedures, ranges or specific values for algorithms, procedures or parameters, metrics for evaluation of approaches identified by the system to solve the task, specific hardware to be employed or hardware restrictions to be met, quantum properties to be considered, shots limit for error-related techniques, a desired output quality for the error-related techniques, and/or any other relevant restrictions or constraints.

As stated above, in an embodiment, the user can specify as a constraint, a family of algorithms or a specific algorithm that the system can consider while identifying potential combination of entities for solving the task, such that each potential combination of entities identified by the system can include the algorithm specified by the user as one of the entities. For example, the user can request the system (e.g., specify as input at a UI) to use any variational algorithm (a family of algorithms) or the user can request the system to use a variational quantum cigensolver (VQE) algorithm. The VQE can use a quantum ansatz (a quantum program with tunable parameters) that can run on a quantum hardware, and a classical optimization algorithm that can run on classical hardware and iteratively tune the parameters of the ansatz to optimize a cost function. If the user specifies an algorithm to be used by the system, the system can use only the algorithm specified by the user, whereas if no algorithm is specified by the user, the system can decide the best algorithm to consider for solving the task, based on the input comprising the data, the task to solve and other any constraints specified by the user. In an embodiment, additional algorithms can be included in the combinations of entities identified by the system to run one or more user specified algorithms, and such procedures can be quantum procedures or they can be hybrid procedures wherein classical techniques that can assist a quantum computing portion can be employed.

At 404 of the non-limiting method 400, an intelligent composer (e.g., intelligent composer 314 of FIG. 3) can intelligently compose a set of jobs that can reflect reasonable combinations of resources, algorithms, error-related techniques, parameters, etc. that can be employed to solve the task. In an embodiment, the intelligent composer can employ a simple rule-based system, wherein a set of rules can be defined for which algorithms to choose based on the inputs. The set of rules can be based on expert knowledge and experiences related to previous executions of jobs by the system, and the set of rules can be updated periodically based on hardware changes or new algorithms. In an embodiment, the intelligent composer can employ a brute force approach, wherein different combinations of entities can be run on quantum simulators or inexpensive quantum systems, and wherein the system can measure (e.g., using analysis component 214) which combination of entities provides the highest value for a particular performance metric, wherein the performance metric can be task dependent and potentially specified by the user.

As stated elsewhere herein, the user can define the performance metric to be used by the system to identify and return to the user, the best combination of entities (e.g., N best combinations of entities) for solving the task. For example, the user can specify to the system to find the best solution based on fidelity for an algorithm. Fidelity is a metric in quantum computing that can define how far an actual job is from an ideal result. In other words, a fidelity metric can be used to check how far a solution is from an ideal result. Other similar error-based metrics can be used. For example, the user can specify to the system to find the best solution based on average error, etc. In this case, error-mitigation can be a part of the procedure. However, if no performance metric is specified by the user, the system can automatically decide upon the best performance metric to use to analyze the results from an existing knowledge base. For example, the system can analyze the problem (i.e., the task) and datasets (i.e., the data) provided by the user to the system to identify metrics previously employed by the system for other jobs. The selection of the metric can be based on rules.

At 406 of the non-limiting method 400, the system can send respective combinations of entities identified by the system as respective jobs, to a quantum computing platform that can execute the jobs. For example, job 1, job 2, job 3, and job M can respectively represent combinations of entities that can be employed by the quantum computing platform to generate a solution for the task. The quantum computing platform can execute the jobs in parallel, and the results of the jobs can be analyzed (e.g., by analysis component 214) to identify the best combination(s) of entities to return to the user. In an embodiment, the user or the system can define the max number (max N) of combinations that can be considered for identifying potential combinations of entities that can be employed for solving the task and testing the potential combinations of entities for identifying the best combinations of entities. The max N of combinations can be known as a computational budget. Since quantum computers are currently a scarce resource, it is not possible to grant infinite jobs for execution to a quantum computing platform, and thus a computational budget can be defined. However, in the future, granting more jobs to the quantum computing platform can become a possibility, given advances in quantum computing.

In various embodiments, depending on a configuration and potential combinations of configurations (e.g., entities comprising algorithms, procedures, quantum hardware, error-mitigation techniques, etc.) identified by the intelligent composer, the system can schedule a set of M jobs that can run each combination of configurations. Each combination of defined configurations can use the same quantum hardware with different quantum constraints (e.g., if the user does not restrict entities/specify constraints). The jobs can be parallelized to achieve the set of results faster (e.g., as opposed to running one job after completing another job). Based on previous executions or rules defined by administrators of the system, if the system can determine how to improve a solution, the system can include more combinations of configurations to be executed in the set of jobs.

At 408 of the non-limiting method 400, the system can analyze (e.g., via analysis component 214) an output (i.e., the results) of the jobs against metrics defined by the user.

At 410 of the non-limiting method 400, the results of the jobs can be stored (e.g., via quantum computing platform API 318 of FIG. 3) in a database (e.g., database 326 of FIG. 3).

At 412 of the non-limiting method 400, the results of the jobs can be returned (e.g., via API 312 or quantum computing platform API 318 of FIG. 3) to the user.

Thus, various embodiments herein can provide an intelligent system (e.g., system 100) that can attempt to solve a problem while benchmarking different possible procedures/solutions (e.g., combinations of entities that can be used to solve the problem). In an embodiment, a user can restrict performance metrics to be used by the system for analyzing each possible procedure. For example, the system can analyze results generated by execution of the possible procedures on a quantum computing platform according to performance metrics specified by a user. If the user does not restrict the performance metrics to be employed by the system to evaluate results generated by execution of the possible procedures, the system can automatically decide appropriate performance metrics to be used for a particular task. In an embodiment, the system can identify based on prior knowledge, by using machine learning, deep learning or recommender systems, potential combinations of entities (e.g., quantum procedures, algorithms, hardware, parameters, and/or other entities) that can demonstrate better results for solving a problem, and the system can automatically include such potential combinations of entities in the set of jobs to be executed to benchmark solutions.

In various embodiments, the system can apply different optimizations (e.g., via optimization component 110) at the code level, based on the prior knowledge, to improve the potential combinations of entities (e.g., by using machine learning, neural networks, etc.). Similarly, the system can automatically (and intelligently) enhance the compilation to customize the code for specific hardware, etc. The system can learn about the potential combinations of entities, applicability of the potential combinations of entities to different quantum hardware devices, quantum constraints and features of the potential combinations of entities. In various embodiments, based on availability of hardware, noise properties of the hardware and results of previous executions, the system can choose to run on a specific backend with a specific error mitigation algorithm. For example, some problems need to be executed on low noise hardware while other problems can be more resilient to noise. Further restrictions can be provided by input from the user. For example, as discussed elsewhere herein, the user can request to receive a desired quality of results, a maximum number of shots or a maximum execution time. For example, the user can specify an error percentage (%) limit on an observable. Quantum constraints that can be used to benchmark different solutions can comprise a configuration of a backend, defaults of a backend and/or properties of a backend.

The configuration of the backend can include static information of the quantum device and comprise information like backend_name, backend_version, n_qubits, basis_gates, dt, meas_levels, dtm, meas_map, or any other existing or future basic configurations. The defaults of the backend can define a basic existing configuration of the backend and comprise information fields such as qubit_freq_est, meas_freq_est, buffer, pulse_library, cmd_def, meas_kernel, discriminator, _data, or any other related information in the future. Herein, qubit_freq_est can refer to an estimation of the frequency at which qubits work and meas_freq_est can refer to measurement frequencies. The properties of the backend can define performance gates of the backend, including defining which gates can perform better, what the coupling maps can be, or which qubits can be better to use in a specific situation. In addition to general information, gates and qubits, the properties can comprise additional information in the future. The configuration, defaults and properties of the backend can represent typical information coming from quantum backends that can assist a decision-making process of the intelligent composer and can represent examples of data regarding quantum computing.

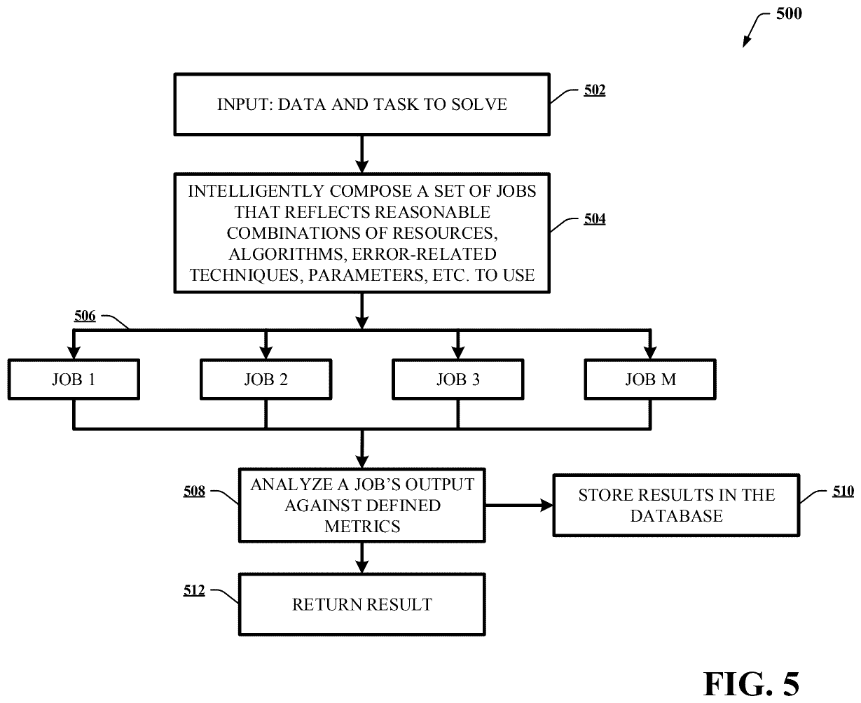

FIG. 5 illustrates a flow diagram of another example, non-limiting method 500 for generating intelligent and automated recommendations of techniques based on quantum computing to solve problems in accordance with one or more embodiments described herein. One or more operations described with respect to FIG. 5 can be performed by one or more components of system 100 of FIGS. 1 and 2. Repetitive description of like elements and/or processes employed in respective embodiments is omitted for sake of brevity.

In an embodiment, a system (e.g., system 100) can benchmark how a solution to a defined task can be reached using one or more combinations of algorithms, parameters, data, quantum procedures, quantum circuits, quantum hardware units and error mitigation, correction or cancelation techniques, based on an input comprising a defined task, datasets, and/or constraints specifying a quantum hardware, noise mitigations techniques, algorithms, properties, metrics for evaluating solutions, and/or other constraints.

At 502 of the non-limiting method 500, a user (e.g., user 302 of FIG. 3) can input data (e.g., data 306 of FIG. 3) and a task to solve (e.g., task 308 of FIG. 3) into a system (e.g., system 100), without specifying constraints or requirements (e.g., constraints 310) for solving the task.

At 504 of the non-limiting method 500, an intelligent composer (e.g., intelligent composer 314 of FIG. 3) can intelligently compose a set of jobs that can reflect reasonable combinations of resources, algorithms, error-related techniques, parameters, etc. that can be employed to solve the task.

At 506 of the non-limiting method 500, the system can send respective combinations of entities identified by the system as respective jobs, to a quantum computing platform that can execute the jobs. For example, job 1, job 2, job 3, and job M can respectively represent combinations of entities that can be employed by the quantum computing platform to generate a solution for the task.

At 508 of the non-limiting method 500, the system can analyze (e.g., via analysis component 214) an output (i.e., the results) of the jobs against metrics defined by the user.

At 510 of the non-limiting method 500, the results of the jobs can be stored (e.g., via quantum computing platform API 318 of FIG. 3) in a database (e.g., database 326 of FIG. 3).

At 512 of the non-limiting method 500, the results of the jobs can be returned (e.g., via API 312 or quantum computing platform API 318 of FIG. 3) to the user.

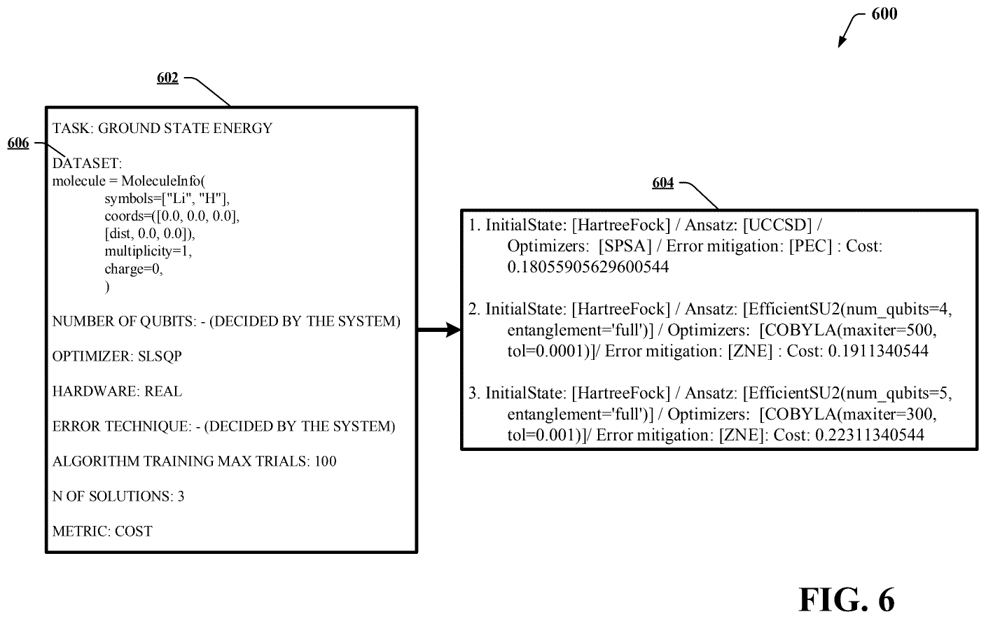

FIG. 6 illustrates a diagram of an example, non-limiting solution 600 comprising an input and a corresponding output including a list of approaches that can be employed to solve a problem in the input in accordance with one or more embodiments described herein. One or more operations described with respect to FIG. 6 can be performed by one or more components of system 100 of FIGS. 1 and 2. Repetitive description of like elements and/or processes employed in respective embodiments is omitted for sake of brevity.

In various embodiments, a system (e.g., system 100) can identify different solutions to a problem based on different combinations of procedures, hardware, etc. For example, given a predefined set of conditions for solving a problem, the system can identify the best potential combinations of entities that can be employed to solve the problem. For example, the system can identify the most appropriate error mitigation technique for a problem, given a context, predefined conditions and so on. In various embodiments, the system can generate initial intelligent recommendations for solving the problem, wherein the recommendations can comprise various combinations of entities that can be employed for solving the problem. The system can attempt to solve the problem using the recommendations and present to the user, results based on execution of the recommendations, according to a performance metric such as quality, fidelity, etc. This can allow the user to solve the problem without having the right knowledge or full knowledge of quantum systems. In some embodiments, the various recommendations presented by the system to the user can mainly be solved using quantum computers, whereas in some embodiments the various recommendations can comprising classical computing steps in addition to quantum computing. For example, solutions can be classically transmitted from a quantum computer to the user.

In FIG. 6, input 602 can be an input provided by a user to a system (e.g., system 100) at a UI. The input can comprise information about a task that the user desires to solve and data needed to solve the task. For example, according to input 602, the task can involve identification of the ground state energy of a molecule and the dataset can include a definition of the molecule such as illustrated at 606. The input can further comprise information about constraints specified by the user for the system to consider when attempting to identify potential combinations of entities that can be used to solve the task. For example, according to input 602, the user can restrict an optimizer to be used in the quantum algorithm to a Sequential Least SQuares Programming (SLSQP) optimizer. Further the user can specify that the hardware to be employed should be a real hardware (e.g., as opposed to a simulator), the maximum number of trials of algorithm training should be 100 and the number of resulting solutions (e.g., N of solutions) should be 3. The user can also specify a performance metric that the system can utilize to analyze results generated by executing the combination of entities identified by the system as potential techniques for solving the task. For example, according to input 602, the user can specify that the performance metric is to be a cost metric. Cost can be a metric that can define how good a result is, and cost can be defined as a decimal number, as illustrated in output 604. For example, the cost for the initial recommendation can be 0.18055905629600544. In the given scenario, a lower the cost can imply a better solution. As such, the cost metric can define how results (e.g., recommendations) can be sorted. Parameters such as a number of qubits and error mitigation techniques to be employed by the system can be decided by the system, if the user does not impose constraints on the parameters.

Based on input 602, the system can return to the user, output 604. Output 604 can comprise proposed solutions (e.g., combinations of entities) recommended by an algorithm of the system, after generating the initial recommendations and analyzing results based on execution of the initial recommendations on a quantum computing platform. For example, output 604 can return to the user, recommendations listed in descending order of performance analyzed by the system based on the performance metric of cost. For example, output 604 can comprise three recommendations, wherein each recommendation can comprise information about the initial state of the molecule, described as HartreeFock that can be a way to prepare an initial state of the molecule. Output 604 can further comprise ansatz used in connection with the optimizer specified by the user and values of the cost metric after running the initial recommendations proposed by the system based on input 602. Output 604 generally illustrates examples of combinations of algorithms and procedures that can be used to solve the task specified in input 602, and entities in each recommendation listed in output 604 can be parts of a real algorithm. The user can view the recommendations as presented in output 604 on a user device such as a computer, laptop, etc.

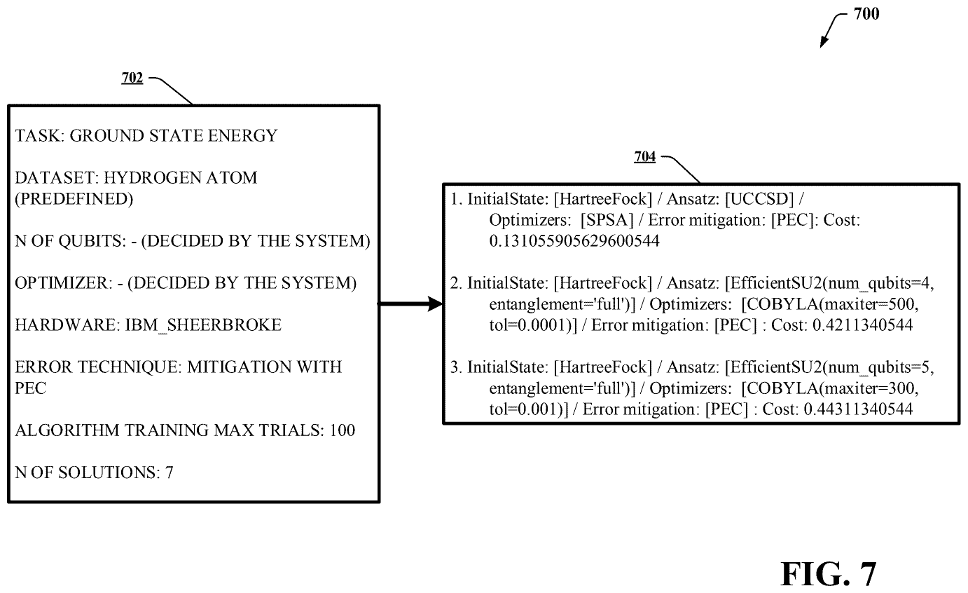

FIG. 7 illustrates a diagram of another example, non-limiting solution 700 comprising an input and a corresponding output including a list of approaches that can be employed to solve a problem in the input in accordance with one or more embodiments described herein. One or more operations described with respect to FIG. 7 can be performed by one or more components of system 100 of FIGS. 1 and 2. Repetitive description of like elements and/or processes employed in respective embodiments is omitted for sake of brevity.

FIG. 7 illustrates the example of FIG. 6 with different constraints. Input 702 can comprise the task of identifying the ground state energy of a Hydrogen atom. However, instead of defining the molecule manually, a predefined example of a dataset can be included in input 702. For example, input 702 can comprise a predefined example of a Hydrogen atom. The example of FIG. 7 illustrates that the hardware, error mitigation technique (e.g., error mitigation with probabilistic error cancellation (PEC)), the maximum number of trials of algorithm training (e.g., 100), and the number of resulting solutions (e.g., 7) are specified by the user in input 702, whereas the number of qubits and the optimizer to be employed for the algorithm can be decided by the system. For example, the system can select different optimizers such as, for example, Simultaneous Perturbation Stochastic Approximation (SPSA) optimizer and Constrained Optimization by Linear Approximation (COBYLA) optimizer, for respective combinations of entities recommended by the system for solving the task of input 702, as illustrated in output 704. The performance metric can be the cost metric as in the example of FIG. 6.

Based on input 702, the system can return to the user, output 704. Output 704 can comprise proposed solutions (e.g., combinations of entities) recommended by an algorithm of the system, after generating the initial recommendations and analyzing results of execution of the initial recommendations on a quantum computing platform. For example, output 704 can return to the user, recommendations listed in descending order of performance, based on analysis of the recommendations by the system using the performance metric of cost. For example, output 704 can comprise a list of recommendations, wherein each recommendation can comprise information about the initial state of the molecule, described as HartreeFock that can be a way to prepare an initial state of the molecule. Output 704 can further comprise ansatz used in connection with the optimizer specified by the user and values of the cost metric after running the initial recommendations proposed by the system based on input 702. Herein, the cost metric can be a default metric. Output 704 generally illustrates examples of combinations of algorithms and procedures that can be used to solve the task specified in input 702, and all entities in each recommendation listed in output 704 can be parts of a real algorithm. The user can view the recommendations as presented in output 704 on a user device such as a computer, laptop, etc. It is to be appreciated that although the examples of FIG. 6 and FIG. 7 illustrate only three outputs, additional outputs can be possible for different scenarios.

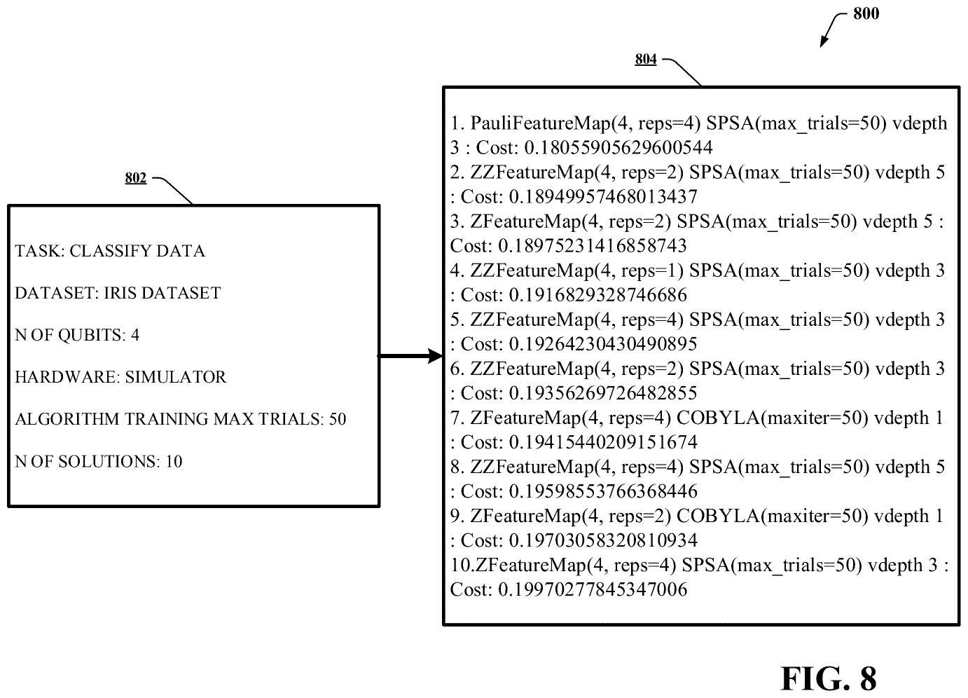

FIG. 8 illustrates a diagram of yet another example, non-limiting solution 800 comprising an input and a corresponding output including a list of approaches that can be employed to solve a problem in the input in accordance with one or more embodiments described herein. One or more operations described with respect to FIG. 8 can be performed by one or more components of system 100 of FIGS. 1 and 2. Repetitive description of like elements and/or processes employed in respective embodiments is omitted for sake of brevity.

FIG. 8 illustrates another example of an output produced by a system (e.g., system 100) that can automatically and intelligently recommend to a user, the best combinations of entities comprising quantum algorithms, procedures, quantum hardware, etc. that can be employed to solve a problem such as a classification problem, an optimization problem, and so on, based on input provided to the system by the user.

As illustrated in FIG. 8, the user can provide input 802 to the system, and input 802 can comprise information about a task to be solved, data needed to solve the task and one or more constraints that can be specified by the user. For example, according to input 802, the task to be solved can involve classification of data and a predefined dataset such as the Iris dataset can be provided as part of input 802. Further, the user can specify constraints as part of input 802. For example, the user can specify that the system should execute the combinations of entities recommended by the system on a simulator instead of a real quantum hardware. The user can also specify the number of qubits to be utilized by the system (e.g., 7 qubits), the maximum number of trials of algorithm training (e.g., 50) and the number of resulting solutions (e.g., 10). The performance metric can be the cost metric, as in the examples of FIGS. 6 and 7. Herein, the cost metric can be a default metric.

Based on input 802, the system can return to the user, output 804. Output 804 can comprise proposed solutions (e.g., combinations of entities) recommended by an algorithm of the system, after generating the initial recommendations and analyzing results based on execution of the initial recommendations on a quantum computing platform. For example, output 804 can return to the user, recommendations listed in descending order of performance based on analysis of the recommendations by the system using the performance metric of cost. For example, output 804 can comprise a list of recommendations, wherein each recommendation can comprise information about the quantum algorithm employed by the system (e.g., PauliFcatureMap or ZZFeatureMap). Output 804 generally illustrates examples of combinations of algorithms and parameters for the algorithm that can be used to solve the task specified in input 802, and all entities in each recommendation listed in output 804 can be parts of a real algorithm. The user can view the recommendations as presented in output 804 on a user device such as a computer, laptop, etc.

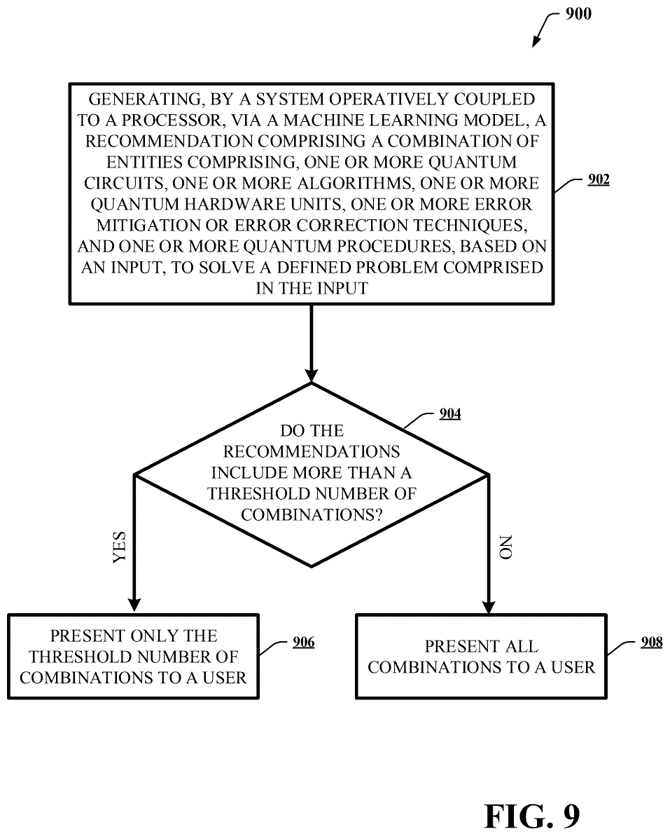

FIG. 9 illustrates a flow diagram of an example, non-limiting method 900 that can enable intelligent and automated recommendations of techniques based on quantum computing to solve problems in accordance with one or more embodiments described herein. One or more operations described with respect to FIG. 9 can be performed by one or more components of system 100 of FIGS. 1 and 2. Repetitive description of like elements and/or processes employed in respective embodiments is omitted for sake of brevity.

At 902, the non-limiting method 900 can comprise generating (e.g., by recommendation component 108), by a system operatively coupled to processor, via a machine learning model, a recommendation comprising a combination of entities comprising, one or more quantum circuits, one or more algorithms, one or more quantum hardware units, one or more error mitigation or error correction techniques, and one or more quantum procedures, based on an input, to solve a defined problem comprised in the input.

At 904, the non-limiting method 900 can comprise determining (e.g., by recommendation component 108), whether the recommendations include more than a threshold number of combinations.

If yes, at 906, the non-limiting method 900 can comprise presenting only the threshold number of combinations to a user (e.g., after executing the combinations on a quantum computing platform and analyzing the results generated based on the executing).

If not, at 908, the non-limiting method 900 can comprise presenting all combinations to a user (e.g., after executing the combinations on a quantum computing platform and analyzing the results generated based on the executing).

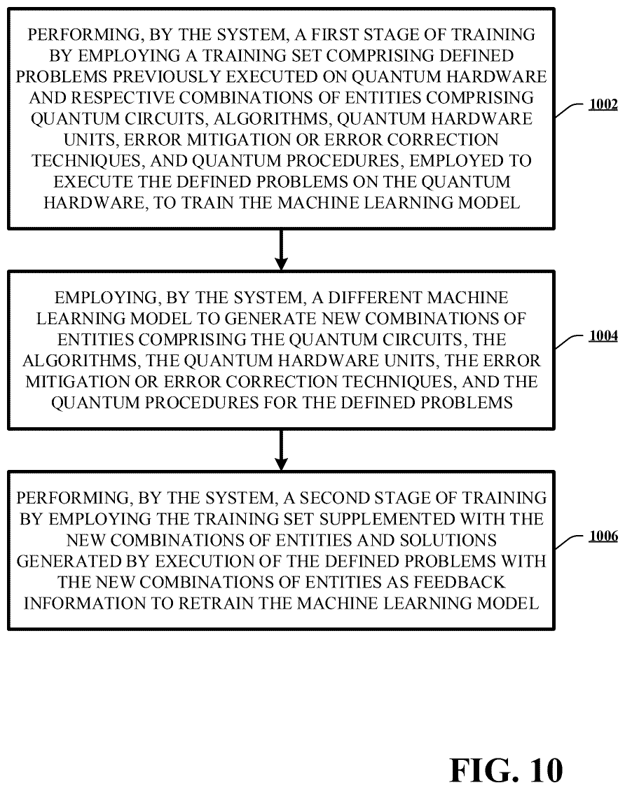

FIG. 10 illustrates a flow diagram of an example, non-limiting method 1000 to train a machine learning model to generate intelligent and automated recommendations of techniques based on quantum computing to solve problems in accordance with one or more embodiments described herein.

With continued reference to non-limiting method 900, non-limiting method 1000 illustrates a training method to train the machine learning model employed to generate the recommendation.

At 1002, the non-limiting method 1000 can comprise performing (e.g., by training component 112), by the system, a first stage of training by employing a training set comprising defined problems previously executed on quantum hardware and respective combinations of entities comprising quantum circuits, algorithms, quantum hardware units, error mitigation or error correction techniques, and quantum procedures, employed to execute the defined problems on the quantum hardware, to train a machine learning model.

At 1004, the non-limiting method 1000 can comprise employing (e.g., by training component 112), by the system, a different machine learning model to generate new combinations of entities comprising the quantum circuits, the algorithms, the quantum hardware units, the error mitigation or error correction techniques, and the quantum procedures for the defined problems.

At 1006, the non-limiting method 1000 can comprise performing (e.g., by training component 112), by the system, a second stage of training by employing the training set supplemented with the new combinations of entities and solutions generated by execution of the defined problems with the new combinations of entities as feedback information to retrain the machine learning model.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively identify one or more combinations of entities comprising quantum algorithms, quantum hardware units, error mitigation techniques, procedures, parameters, etc. that can be implemented to solve optimization problems, classification problems and so on, as the one or more embodiments described herein can enable this process. And, neither can the human mind nor a human with pen and paper analyze results, generated by execution of the one or more combinations of entities on a quantum computing platform, based on a performance metric, to identify the best combinations of entities in connection with a particular problem, as conducted by one or more embodiments described herein.

Various embodiments discussed herein can provide an intelligent system that can provide improvements to a quantum computing platform. For example, the intelligent system can assist researchers to discover new ways of solving quantum-computing related tasks and to test different combinations of algorithms, parameters, procedures, and hardware to solve problems and find optimal solutions that can improve upon existing solutions. Further, the intelligent system can help practitioners test different solutions and understand how various procedures, hardware units, and algorithms can affect problem solutions and discover new ways of solving quantum-computing related tasks. As such the various embodiments discussed herein can provide a number of advantages, including assisting researchers and practitioners with automating a discovery of solutions to problems (e.g., optimization problems, computational problems, etc.) by automatically identifying combinations of existing quantum algorithms, procedures, configurations, parameters, and quantum hardware units that can be employed for solving the problems, assisting users with benchmarking how feasible different tasks can be, based on an existing set of quantum computing-based resources, and assisting users in selection of error mitigation strategies that can be suitable for a problem provide by the users and a hardware specified by the users.

FIG. 11 illustrates a block diagram of an example, non-limiting operating environment 1100 in which one or more embodiments described herein can be facilitated. FIG. 11 and the following discussion are intended to provide a general description of a suitable operating environment 1100 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as automatic quantum computing solution recommendation code 1145. In addition to block 1145, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1145, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1145 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1145 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, cither as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be cither hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be cither volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer-executable components; and
a processor that executes the computer-executable components stored in the memory, wherein the computer-executable components comprise:
a recommendation component that employs a machine learning model to generate, based on an input, a recommendation comprising a combination of entities comprising, one or more quantum circuits, one or more algorithms, one or more quantum hardware units, one or more error mitigation or error correction techniques, and one or more quantum procedures, to solve a defined problem comprised in the input.

2. The system of claim 1, further comprising:
a training component that trains the machine learning model to generate the recommendation without executing the input on a quantum computing platform, wherein training the machine learning model comprises:
performing a first stage of training by employing a training set comprising defined problems previously executed on quantum hardware and respective combinations of entities comprising quantum circuits, algorithms, quantum hardware units, error mitigation or error correction techniques, and quantum procedures, employed to execute the defined problems on the quantum hardware, to train the machine learning model, and employing a different machine learning model to generate new combinations of entities comprising the quantum circuits, the algorithms, the quantum hardware units, the error mitigation or error correction techniques, and the quantum procedures for the defined problems;
performing a second stage of training by employing the training set supplemented with the new combinations of entities and solutions generated by execution of the defined problems with the new combinations of entities as feedback information to retrain the machine learning model.

3. The system of claim 1, wherein the input further comprises one or more datasets corresponding to the defined problem, and wherein the combination of entities further comprises parameters for solving the defined problem.

4. The system of claim 1, wherein the recommendation component recommends the combination of entities based on one or more constraints selected from a group comprising at least one of the one or more quantum circuits, the one or more algorithms, the one or more quantum hardware units, the one or more error mitigation or error correction techniques, the one or more quantum procedures, hybrid procedures and parameters.

5. The system of claim 1, further comprising:
an optimization component that applies various optimizations at an algorithm level, based on knowledge of techniques previously employed to solve the defined problem, to customize an algorithm of the one or more algorithms.

6. The system of claim 1, wherein the recommendation component recommends at least a second combination of entities to solve the defined problem, wherein the at least a second combination of entities comprises additional or fewer entities than the combination of entities.

7. The system of claim 6, wherein the combination of entities and the at least a second combination of entities are executed in parallel on a quantum computing platform to generate respective results for the defined problem based on the combination of entities and the at least a second combination of entities.

8. The system of claim 7, further comprising:
an analysis component that analyzes the respective results against evaluation metrics for the defined problem to identify an optimal combination of entities for solving the defined problem.

9. A computer-implemented method, comprising:
generating, by a system operatively coupled to a processor, via a machine learning model, a recommendation comprising a combination of entities comprising, one or more quantum circuits, one or more algorithms, one or more quantum hardware units, one or more error mitigation or error correction techniques, and one or more quantum procedures, based on an input, to solve a defined problem comprised in the input.

10. The computer-implemented method of claim 9, further comprising:
training, by the system, the machine learning model to generate the recommendation without executing the input on a quantum computing platform, wherein the training comprises:
performing, by the system, a first stage of training by employing a training set comprising defined problems previously executed on quantum hardware and respective combinations of entities comprising quantum circuits, algorithms, quantum hardware units, error mitigation or error correction techniques, and quantum procedures, employed to execute the defined problems on the quantum hardware, to train the machine learning model, and employing a different machine learning model to generate new combinations of entities comprising the quantum circuits, the algorithms, the quantum hardware units, the error mitigation or error correction techniques, and the quantum procedures for the defined problems; and
performing, by the system, a second stage of training by employing the training set supplemented with the new combinations of entities and solutions generated by execution of the defined problems with the new combinations of entities as feedback information to retrain the machine learning model.

11. The computer-implemented method of claim 9, wherein the input further comprises one or more datasets corresponding to the defined problem, and wherein the combination of entities further comprises parameters for solving the defined problem.

12. The computer-implemented method of claim 9, wherein the recommendation component recommends the combination of entities based on one or more constraints selected from a group comprising at least one of the one or more quantum circuits, the one or more algorithms, the one or more quantum hardware units, the one or more error mitigation or error correction techniques, the one or more quantum procedures, hybrid procedures and parameters.

13. The computer-implemented method of claim 9, further comprising:
applying, by the system, various optimizations at an algorithm level, based on knowledge of techniques previously employed to solve the defined problem, to customize an algorithm of the one or more algorithms.

14. The computer-implemented method of claim 9, further comprising:
recommending, by the system, at least a second combination of entities to solve the defined problem, wherein the at least a second combination of entities comprises additional or fewer entities than the combination of entities.

15. The computer-implemented method of claim 14, wherein the combination of entities and the at least a second combination of entities are executed in parallel on a quantum computing platform to generate respective results for the defined problem based on the combination of entities and the at least a second combination of entities.

16. The computer-implemented method of claim 15, further comprising:
analyzing, by the system, the respective results against evaluation metrics for the defined problem to identify an optimal combination of entities for solving the defined problem.

17. A computer program product for solving problems related to quantum computing, the computer program product comprising a computer readable storage medium having program instructions embodied therewith, the program instructions executable by at least one processor to cause the at least one processor to:
generate, by the at least one processor, via a machine learning model, a recommendation comprising a combination of entities comprising, one or more quantum circuits, one or more algorithms, one or more quantum hardware units, one or more error mitigation or error correction techniques, and one or more quantum procedures, based on an input, to solve a defined problem comprised in the input.

18. The computer program product of claim 17, wherein the input further comprises one or more datasets corresponding to the defined problem, and wherein the combination of entities further comprises parameters for solving the defined problem.

19. The computer program product of claim 17, wherein the program instructions are further executable by the at least one processor to cause the at least one processor to:
recommend, by the at least one processor, the combination of entities based on one or more constraints selected from a group comprising at least one of the one or more quantum circuits, the one or more algorithms, the one or more quantum hardware units, the one or more error mitigation or error correction techniques, the one or more quantum procedures, hybrid procedures and parameters.

20. The computer program product of claim 17, wherein the program instructions are further executable by the at least one processor to cause the at least one processor to:
apply, by the at least one processor, various optimizations at an algorithm level, based on knowledge of techniques previously employed to solve the defined problem, to customize an algorithm of the one or more algorithms.
